(19) United States
(12) Patent Application Publication
(10) Pub. No.: US 2025/0001891 A1
(43) Pub. Date: Jan. 2, 2025

(54) INTELLIGENT CHARGING MANAGEMENT SYSTEM AND CHARGING MANAGEMENT DEVICE THEREOF

(71) Applicant: Neopower Technologies co., Ltd., Taipei City (TW)

(72) Inventors: Chia-Wen CHAN, Taipei City (TW); Yi-Hsuan HUNG, Taipei City (TW); Syuan-Yi CHEN, Taipei City (TW); Chien-Hsun WU, Taipei City (TW); Ling-Chieh HSU, Taipei City (TW)

(21) Appl. No.: 18/747,413

(22) Filed: Jun. 18, 2024

(30) Foreign Application Priority Data
Jun. 27, 2023 (TW) 112123952

(51) Int. Cl. B60L 53/62; B60L 53/67; B60L 53/68

(52) U.S. Cl. CPC B60L 53/62; B60L 53/67; B60L 53/68

(57) ABSTRACT

The present disclosure is related to an intelligent charging management system, a charging management device, and a charging management method. The charging management device is used to execute the charging management method for determining a chargeable power value of the electric vehicle according to an operation mode of the electric vehicle and an available capacity of a charging point, and determining a charging parking lot for providing to the electric vehicle according to the chargeable power value of the electric vehicle and available charging parking lots of the charging point. In the way, the charging power and charging parking lots of the charging point can be allocated according to the charging requirements of electric vehicles, electric vehicles can be accurately and efficiently charged and the damage caused by charging current to the battery is reduced, so as the purpose for improving charging efficiency of the charging point is determined.

### CROSS-REFERENCES

This application claims the benefit of priority to patent application Ser. No. 11/212,3952, filed in Taiwan on Jun. 27, 2023; the entirety of which is incorporated herein by reference for all purposes.

### TECHNICAL FIELD

The application is related to a charging management system, a charging management device, and a charging management method, and particularly to an intelligent charging management system, a charging management device, and a charging management method for charging points for electric vehicles.

### DESCRIPTION OF RELATED ART

In recent years, with the advancement of electric vehicle-related technologies and a surge in environmental awareness, electric vehicles have become increasingly popular. Many transportation tools have followed the trend to replace gasoline-powered vehicles with electrically powered ones so as to better meet public demand. Consequently, the demand for the deployment of charging points has significantly increased.

Generally, electric vehicles going to a station for charging are coming with different charging requirements. The charging power for charging electric vehicles provided by conventional charging points is usually a fixed value. Therefore, it is not possible to automatically allocate power according to different charging needs, leading to low overall charging efficiency at the charging point. Thus, how to charge electric vehicles more accurately and efficiently so as to improve the charging efficiency of charging points, is one of the problems of the field to be solved.

### SUMMARY OF THE INVENTION

To address the aforementioned technical issues, the application proposes an intelligent charging management system, charging management device, and charging management method. By leveraging the different charging requirements of various electric vehicles and the current charging capacity available at the charging point, the system automatically allocates charging power and charging parking lots to electric vehicles, enabling precise and efficient charging, thereby improving the overall charging efficiency of the charging point.

To achieve the above objectives, an embodiment of the application proposes a charging management method, comprising: determining a chargeable power value of an electric vehicle based on an operation mode of the electric vehicle and an available capacity of a charging point; determining a charging parking lot for the electric vehicle based on the chargeable power value and available charging parking lots in the charging point; and providing information of the charging parking lot to the electric vehicle.

To achieve the above objectives, another embodiment of the application proposes a charging management device, comprising: a memory unit and a processor unit. The memory unit is arranged to operably store a charging management program. The processor unit is electrically connected to the memory unit, arranged for reading and executing the charging management program to perform a charging management method comprising: determining a chargeable power value of an electric vehicle based on an operation mode of the electric vehicle and an available capacity of a charging point; determining a charging parking lot for the electric vehicle based on the chargeable power value and available charging parking lots in the charging point; and providing information of the charging parking lot to the electric vehicle.

To achieve the above objectives, another embodiment of the application proposes an intelligent charging management system, comprising a plurality of charging stations and the charging management device. Thea plurality of charging stations are arranged at a charging point. The charging management device is communicatively connected to the plurality of charging stations, outputting a charge current command to a corresponding charging station based on a chargeable power value of an electric vehicle.

Based on the above, the charging management device disclosed in the application may determine the chargeable power value for an electric vehicle based on the current operation mode of the electric vehicle and the available capacity of the charging point. Suitable charging parking lots may be arranged based on the chargeable power value of the electric vehicle. Therefore, charging power and parking lots for electric vehicles may be automatically allocated according to diverse charging requirements, such that the electric vehicles are effectively and accurately charged, and the overall charging efficiency of the charging point is improved.

### BRIEF DESCRIPTION OF DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a schematic diagram of an intelligent charging management system according to an embodiment of the application.

FIG. 2 shows another schematic diagram of the intelligent charging management system according to an embodiment of the application.

FIG. 3 shows a schematic diagram of the charging management device architecture according to an embodiment of the application.

FIG. 4 shows a schematic diagram of a charging point environment according to an embodiment of the application.

FIG. 5 is a flowchart of the charging management method according to an embodiment of the application.

FIG. 6 is a flowchart of the shift start mode according to an embodiment of the application.

FIG. 7 is a flowchart of the charging mode in general mode according to an embodiment of the application.

FIG. 8 is a flowchart of the automatic mode under the shift start mode according to an embodiment of the application.

FIG. 9 is a flowchart of the process for calculating the chargeable power value under the shift start mode according to an embodiment of the application.

FIG. 10 is a flowchart of the shift end mode according to an embodiment of the application.

FIG. 11 is a flowchart of the automatic mode under the shift end mode according to an embodiment of the application.

FIG. 12 is a flowchart of the process for calculating the chargeable power value under the shift end mode according to an embodiment of the application.

### DESCRIPTION OF THE INVENTION

The following embodiments of the present invention are illustrated by specific examples, those skilled in the art may easily understand other advantages and efficacy of the present invention from the content disclosed in this specification. The present invention may also be implemented or applied by different specific embodiments, the details of the present specification may also be based on different views and applications, without departing from the spirit of the present invention to carry out various modifications or changes.

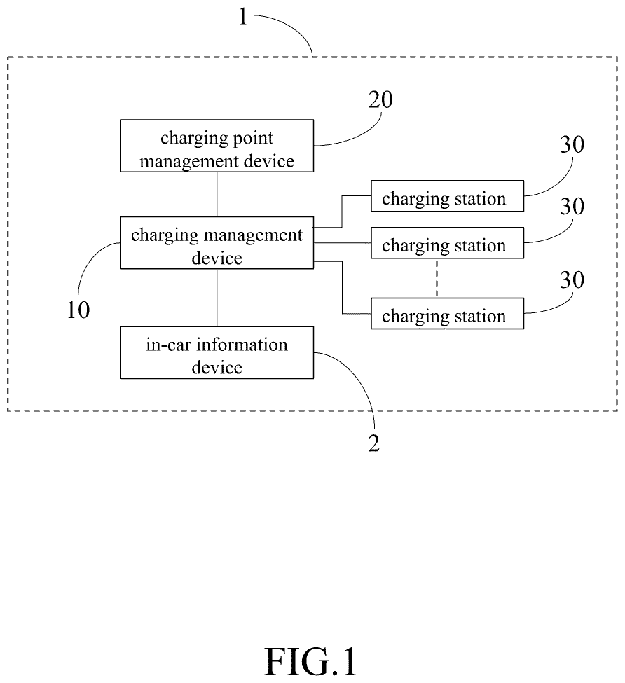

Please refer to FIG. 1, which is a schematic diagram of an embodiment of the intelligent charging management system according to the application. The intelligent charging management system 1 comprises a charging management device 10, a charging point management device 20, and a plurality of charging stations 30. The charging management device 10 is communicatively connected to the charging point management device 20 and the plurality of charging stations 30.

The plurality of charging stations 30 are installed within a charging point, where each charging station 30 is attachable to at least one electric vehicle, performing power recharging based on a received charge current command. The charging point management device 20 is used to store a daily service schedule for multiple electric vehicles and the basic information of related charging points. The charging points management device 20 also provides the daily service schedule and the basic information of charging points to the charging management device 10. In one embodiment, electric vehicles may comprise electric buses, electric transport vehicles, and other vehicles powered by electricity, but the actual implementations of the instant application are not limited to these examples. In one embodiment, the basic information of charging points may comprise a charging point's contracted capacity, number of charging stations, number of parking lots, number of vehicles, etc., but the actual implementations of the application are not limited to these examples. In one embodiment, the service schedule may comprise dynamically updated schedule information or fixed schedule information, and the actual implementations of the application are not limited to these.

The charging management device 10 is used to execute a charging management method. Furthermore, the charging management device 10 may be used to receive real-time charging station data from multiple charging stations 30 and continuously monitor operation statuses of the charging stations 30. The charging management device 10 further communicates with an in-car information device 2 to determine vehicle data corresponding to an electric vehicle and determines based on the received vehicle data whether the electric vehicle is ready to enter the charging point for charging. The charging management device 10 also calculates the chargeable power value for an electric vehicle based on the current operation mode of the electric vehicle, and the current available capacity of the charging point. The charging management device 10 then determines a charging parking lot for the electric vehicle based on the chargeable power value and the current available charging parking lots of the charging point, and provides the electric vehicle with information about the assigned charging parking lot. Based on the chargeable power value of the electric vehicle, the charging management device 1 issues a charge current command to the corresponding charging station. The way, drivers of electric vehicles preparing to enter the charging point for charging can quickly find the location of their assigned charging parking lot from the information provided by the charging management device 10, so as to charge their vehicles at appropriate chargeable power values. Precise and efficient charging is achieved to enhance the charging efficiency of the charging point.

In one embodiment, the vehicle data comprises the license plate information, state of charge (SOC), location information, battery temperature, and etc., wherein the actual implementation of present application is not limited thereto. In one embodiment, the location information may include but not limited to the GPS location data.

In one embodiment, the real-time charging station data comprises at least a charging station ID, the charging gun status, the remaining battery level, and etc. Note that the actual implementation of the present application is not limited thereto.

In one embodiment, the in-car information device 2 may be a vehicle-mounted device inside the electric vehicle, or a vehicle information server that communicates with the vehicle-mounted device of the electric vehicle for receiving the vehicle data. Note that the actual implementation of the present application is not limited thereto.

In one embodiment, the charging management device 10 and the charging point management device 20 can be implemented as either local servers or cloud servers for the charging point, and the actual implementation of the present application is not limited to the.

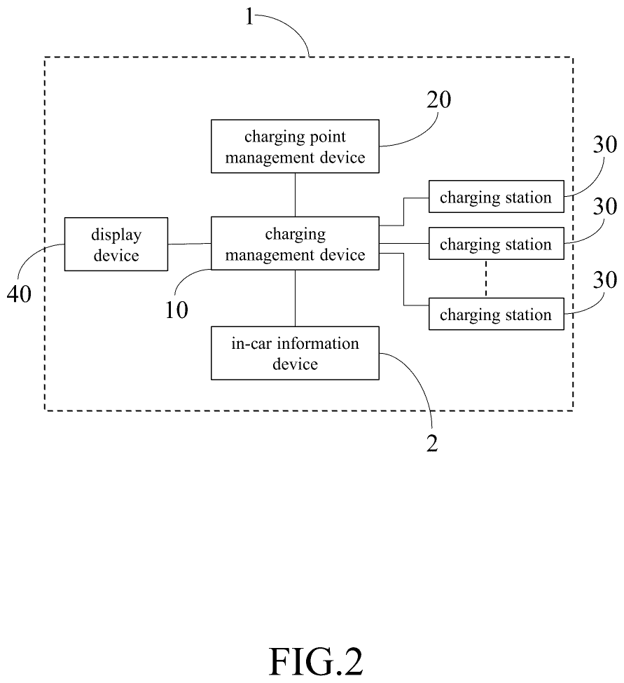

Please refer to FIG. 2. In the embodiment of FIG. 2, the intelligent charging management system 1 further comprises a display device 40. The display device 40 is used to receive and show vehicle data from the intelligent charging management system 1, as well as information about charging parking lots, allowing drivers of electric vehicles to quickly understand the charging statuses of their vehicles by viewing the vehicle data and charging parking lot information displayed on the display device 40. The embodiment enhances the convenience of managing the charging status of electric vehicles. In one embodiment, by viewing the vehicle data and the charging parking lot information displayed on the display device 40, drivers can instantly grasp the charging queue status of their electric vehicles. When their vehicles are ready to be charged, based on the charging parking lot information provided by the display device 40, they can quickly move their vehicles to the designated charging parking lot for charging, thereby effectively improving the usage efficiency of charging parking lots.

In one embodiment, the display device 40 can visualize the vehicle data and charging parking lot information in a data visualization manner, providing a more intuitive understanding of the charging status of electric vehicles, wherein the actual implementation of the application is not limited to the.

In one embodiment, the display device 40 is a liquid crystal display (LCD), but the actual implementation of the application is not limited thereto.

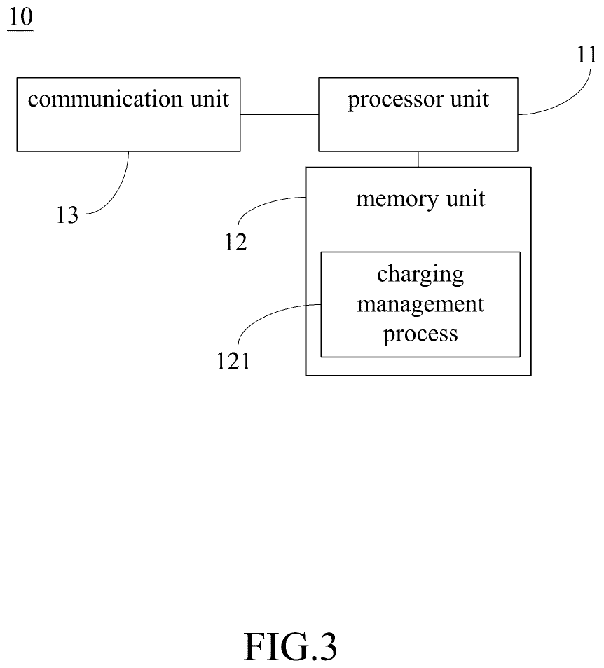

Please refer to FIG. 3. FIG. 3 illustrates an exemplary architecture of the charging management device 10. In the embodiment, the charging management device 10 further comprises a processor unit 11, a memory unit 12, and a communication unit 13. The processor unit 11 is electrically connected to the memory unit 12 and the communication unit 13. The processor unit 11 is used to read and execute the charging management process 121 stored in the memory unit 12 to perform a charging management method. Based on the charging management method, the charging management device 10 exchanges data with the charging point management device 20 and other devices such as multiple charging stations 30 through the communication unit 13. Further detailed embodiments regarding the operational method of the charging management device 10 will be explained as follows.

In one embodiment, the charging management device 10 can be implemented as a server, such as a local server or a cloud server, but the actual implementation of the application is not limited thereto.

In one embodiment, the memory unit 12 can be a storage device such as Dynamic Random Access Memory (RAM), Read-Only Memory (ROM), Flash Memory, a hard drive, and the like, but the actual implementation of the application is not limited thereto.

In one embodiment, the communication unit 13 may be implemented as a communication circuit compatible with Wireless Local Area Networks (WLAN), mobile communication networks, and the like, but the actual implementation of the application is not limited thereto.

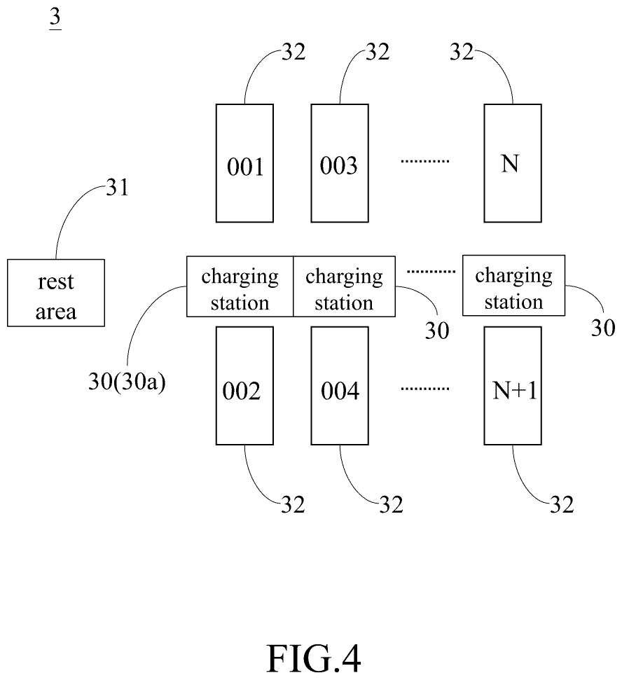

Please refer to FIG. 4, a schematic diagram of the environmental of the charging point according to an embodiment of the application. In the embodiment, the charging point 3 comprises a rest area 31, multiple charging stations 30, and several charging parking lots 32 set corresponding to the charging stations 30, with each charging parking lot 32 corresponding to a specific charging parking lot information (such as a parking lot number). For example, FIG. 3 comprises charging parking lots 32 respectively corresponding to parking lot numbers 001 to 004. The parking lot numbers 001 to 004 serve as the charging parking lot information for the charging parking lots 32, but the actual implementation of the application is not limited thereto. Furthermore, in the embodiment, it is exemplified that each charging station 30 may have two charging guns, corresponding to two charging parking lots 32. For instance, the charging parking lots 32 with parking lot numbers 001 and 002 correspond to the same charging station 30 (30a), and the electric vehicles at parking lots 001 and 002 are charged individually by different charging guns of the same charging station 30 (30a). In other embodiments, each charging station 30 may also be equipped with only one charging gun, but the actual implementation of the application is not limited thereto. In some embodiment, the aforementioned display device 40 can be set up within the rest area 31, allowing drivers to check the charging statuses of their electric vehicles using the display device 40 while the vehicles are charging in the rest area 31. In one embodiment, by viewing the display device 40, drivers are allowed to instantly understand the charging queue status of their electric vehicles. When their vehicles are ready to be charged, based on the charging parking lot information provided by the display device 40, the drivers are allowed to quickly move their vehicles to the designated charging parking lots 32 for charging, thereby effectively enhancing the usage efficiency of the charging parking lots 32.

Next, the embodiments of a charging management method of the application will be described in conjunction with the above FIG. 1 to FIG. 4.

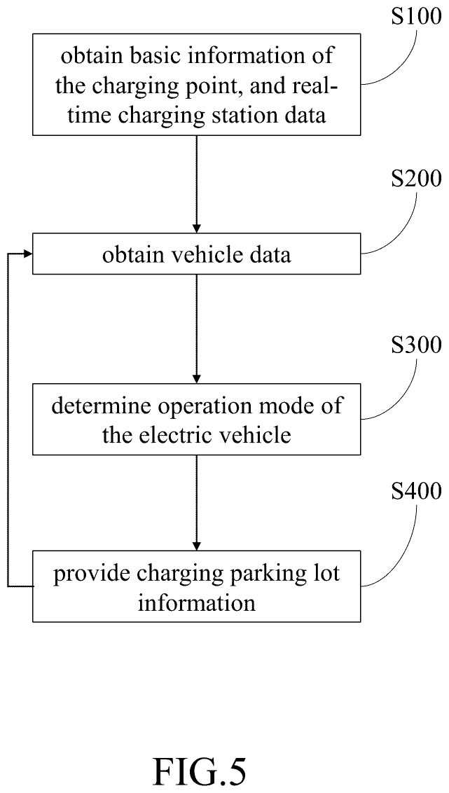

Please refer to FIG. 1 to FIG. 5 simultaneously. FIG. 5 is a flowchart of the charging management method according to an embodiment of the application, wherein the charging management method comprises steps S100, S200, S300, and S400.

In step S100, the basic information of the charging point, and real-time charging station data are obtained. In the embodiment, the charging management device 10 establishes communicative connections with the charging point management device 20 and multiple charging stations 30 to obtain basic information of charging points from the charging point management device 20, and the real-time charging station data from the multiple charging stations 30. The charging management device 10 may be able to determine the contract capacity of the charging point 3, the configuration relationship between each charging station 30 and charging parking lot 32 based on the basic information of charging points, and obtain information such as whether each charging station 30 can operate normally based on real-time charging station data, confirming the available charging stations 30 and charging parking lots 32 for the day.

In step S200, the vehicle data is obtained. In the embodiment, after confirming the available capacity of the charging point 3, the available charging stations 30, and the charging parking lots 32 for the day in step S100, the charging management device 10 continuously obtains vehicle data of multiple electric vehicles from the in-car information devices 2 respectively. The embodiment allows for real-time monitoring of each electric vehicle's operation status based on the service schedule thereof, and determining whether a vehicle is prepared to return to the charging point 3. Furthermore, the charging management device 10 determines based on the location information in the vehicle data, that an electric vehicle is about to enter the charging point 3 when the distance between the vehicle and the charging point is equal to or less than a predetermined distance. In one embodiment, the charging management device 10 compares the location information in the vehicle data with predetermined location information to determine that the electric vehicle is about to enter the charging point 3 when the calculated distance between the vehicle and the charging point, based on the location information, is equal to or less than the predetermined distance. The predetermined location information, for example, may be GPS location information, and the predetermined distance may be 500 meters, but the actual implementation of the application is not limited thereto.

In step S300, the operation mode of the electric vehicle is determined. In the embodiment, when the charging management device 10 determines that the electric vehicle is ready to enter the charging point 3 based on step S200, the charging management device 10 further determines the operation mode of the electric vehicle based on the dormant duration of the electric vehicle. In the embodiment, the charging management device 10 determines the dormant duration of the electric vehicle based on the arrival time of the electric vehicle and the departure time of the next shift in the service schedule. In one embodiment, if the departure time of the next shift in the service schedule is later than the arrival time of the electric vehicle of the same day, the operation mode is determined to be the “on-shift” mode; if the departure time of the next shift in the service schedule is the earliest shift in the service schedule for the next day, the operation mode of the electric vehicle is determined to be the “off-shift” mode.

In step S400, the charging parking lot information is provided. In the embodiment, the charging management device 10 determines the chargeable power value and the charging parking lot 32 for the electric vehicle based on its operation mode, and provides charging parking lot information to the electric vehicle. Thus, when the electric vehicle enters the charging point, the driver of the electric vehicle can quickly drive into the assigned charging parking lot 32 based on the charging parking lot information to get charged with the corresponding chargeable power value. In the embodiment, the charging management device 10 further updates the current available capacity and available charging parking lots of the charging point 3 based on the chargeable power value allocated to the electric vehicle and the charging parking lot 32.

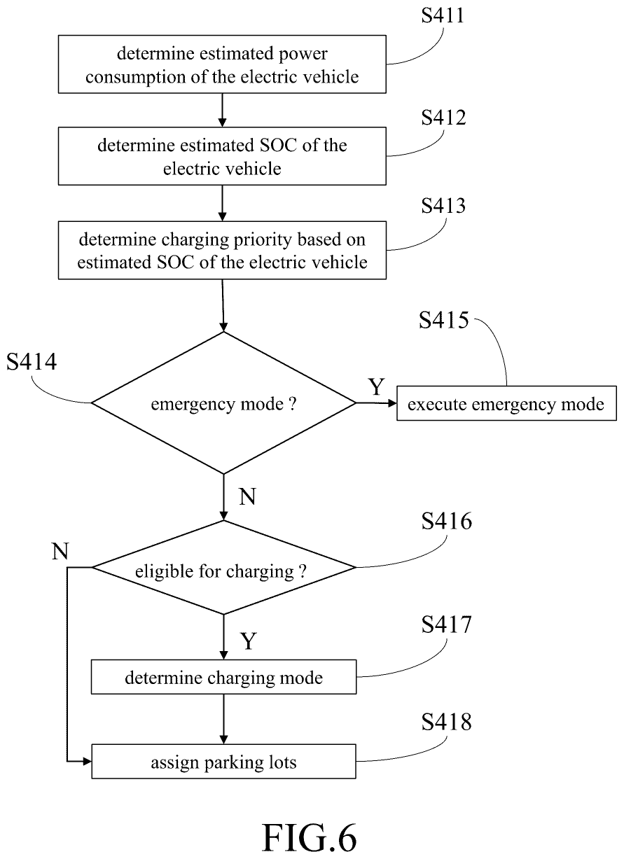

In one embodiment, step S400 of FIG. 5 further comprises steps S411 to S418, as shown in FIG. 6, a flowchart of the charging management method under the on-shift mode according to an embodiment of the present application.

In step S411, the estimated power consumption of the electric vehicle is determined. In the embodiment, the charging management device 10 calculates the estimated power consumption based on the total travel distance of the electric vehicle in the next shift, for example, by using the average power consumption per kilometer of the electric vehicle. In one embodiment, the unit of dormant duration is in minutes, and the actual implementation of present application is not limited thereto.

In step S412, the estimated SOC of the electric vehicle is determined. In the embodiment, the charging management device 10 calculates the estimated SOC of the electric vehicle based on the instantaneous SOC obtained from the vehicle information when the electric vehicle enters the charging point, as well as the estimated power consumption. Furthermore, the charging management device 10 subtracts the estimated power consumption from the instantaneous SOC to determine the estimated SOC of the electric vehicle.

In step S413, the charging priority is determined based on the estimated SOC of the electric vehicle. In the embodiment, the charging management device 10 determines whether the instantaneous SOC of the electric vehicle is sufficient to provide the estimated power consumption required for the next scheduled trip based on the estimated SOC. Moreover, when multiple electric vehicles are ready for charging upon arrival at the charging point, the charging management device 10 prioritizes the electric vehicles for charging based on their estimated SOCs, where a lower estimated SOC corresponds to a higher priority in the charging sequence. Since a lower estimated SOC indicates a more urgent need for charging, the charging management device 10 can quickly arrange charging based on charging priorities to meet the demands for charging.

In step S414, it is determined whether to activate an emergency mode. In the embodiment, the charging management device 10 determines whether emergency mode information is received to trigger the emergency mode. If affirmative, the process goes to step S415; otherwise, the process goes to step S416. In one scenario, on-site personnel can use electronic devices connected to the charging point management device 20 or the charging management device 10 to send emergency mode information based on the urgent charging needs of an electric vehicle. The emergency mode information comprises the vehicle's onboard information, required power level, and charging parking lot information, with the latter being provided to the electric vehicle.

In step S415, the emergency mode is executed. In the embodiment, the charging management device 10, upon receiving the emergency mode information, updates the available capacity and parking lots at the charging point 3. Furthermore, the charging management device 10 deducts the required power level from the available capacity of the charging point 3, excludes the charging parking lot information provided in the emergency mode information from the available parking lots, and thereafter updates the information about available capacity and parking lots at the charging point 3.

In step S416, the charging eligibility is determined. In the embodiment, the charging management device 10 determines the charging eligibility of the electric vehicle based on the dormant duration determined in Step S300. When the electric vehicle is deemed eligible for charging, the process goes to step S417; otherwise, step S418 is proceeded. For example, if the dormant duration of the electric vehicle is less than a predefined threshold, it is considered ineligible for charging. In one embodiment, the predefined dormant duration could be but not limited to 1 hour. Such an arrangement helps preventing the electric vehicles from being charged too frequently, which not only reduces charging efficiency but also occupies charging parking lots, leading to a decrease in overall charging efficiency at the charging point 3.

In step S417, the charging mode is determined. In the embodiment, the charging management device 10 determines whether electric vehicles at the charging point 3 should be charged in normal mode or automatic mode based on the number of electric vehicles present. For example, the charging management device 10 assesses whether the number of electric vehicles at the charging point 3 exceeds a predefined threshold. If the number exceeds a predefined threshold, the electric vehicles are charged in automatic mode; otherwise, they are charged in normal mode. In one embodiment, the predefined threshold could be the ratio of the maximum available capacity of the charging point 3 to the maximum charging power of the charging station 30.

In step S418, the parking lot assignment is executed. In the embodiment, the charging management device 10 determines a charging parking lot 32 assigned for an electric vehicle based on the results of steps S416 and S417. In cases where Step S416 determines that the electric vehicle is not eligible for charging, the charging management device 10 may assign a parking lot without a charging station 30 to the electric vehicle.

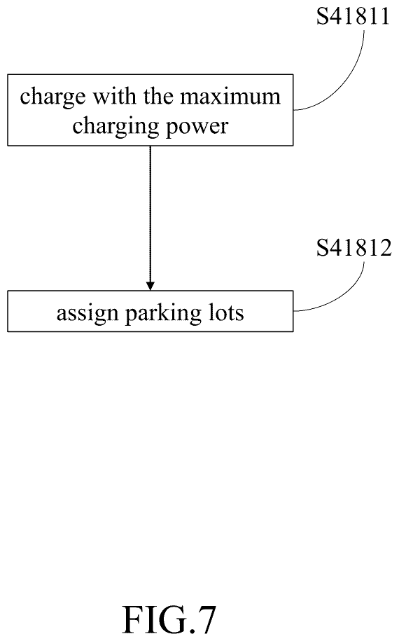

Next, please refer to FIGS. 1 to 7 simultaneously. FIG. 7 illustrates a flowchart of a charging management method where the charging mode is normal mode according to an embodiment of the application. As shown in FIG. 7, in the embodiment, Step S418 further comprises Step S41811 to Step S41812.

In step S41811, the maximum charging power is employed for charging. In the embodiment, since the number of electric vehicles in the charging point 3 has not exceeded a predetermined number, indicating that the charging point 3 has sufficient available capacity to charge the electric vehicles on-site, the charging management device 10 enables the electric vehicle to charge at the maximum charging power of the charging station 30. In the embodiment, the chargeable power value for the electric vehicle is the maximum charging power of the charging station 30.

In step S41812, a parking lot assignment is performed. In the embodiment, the charging management device 10 allocates the unused charging parking lots 32 to electric vehicles waiting to be charged based on the available charging parking lots. In one embodiment, based on the available charging parking lots, the charging management device 10 prioritizes the assignment of an unused charging parking lot 32 of the charging station 30 that has not yet been allocated to other electric vehicles to an electric vehicle waiting to be charged.

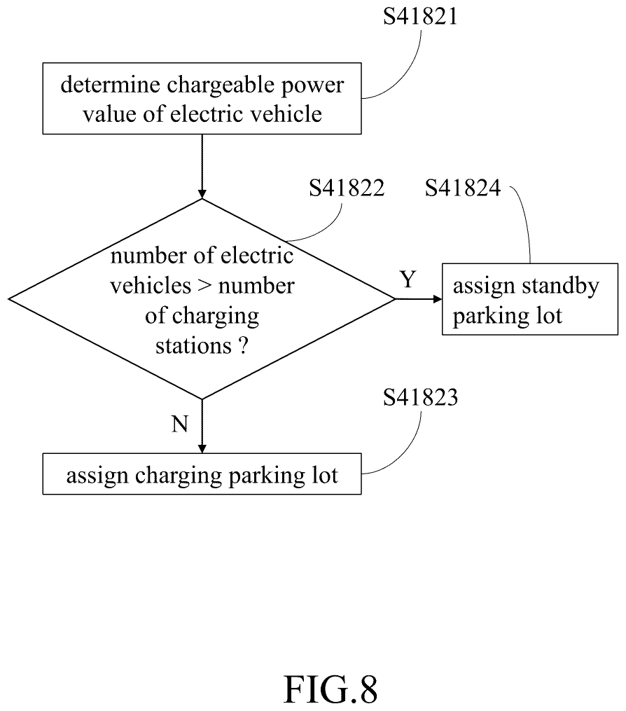

Next, please refer to FIGS. 1 through 8 simultaneously. FIG. 8 is a flowchart of an implementation example of the charging management method where the charging mode is automatic mode. As shown in the embodiment of FIG. 8, Step S418 further comprises Steps S41821 through S41824.

In step S41821, a chargeable power value of the electric vehicle is determined. In the embodiment, the charging management device 10 calculates the chargeable power value of the electric vehicle based on the vehicle's dormant duration, current SOC, estimated SOC, and the available capacity of charging point 3.

In step S41822, it is determined whether the number of electric vehicles is greater than the number of charging stations. In the embodiment, the charging management device 10 determines whether the number of electric vehicles inside the charging point 3 is greater than the number of charging stations. If the determination is negative, step S41823 is processed; otherwise, step S41824 is processed.

In step S41823, a charging parking lots assignment is performed. In the embodiment, the charging management device 10 allocates charging parking lots 32 for electric vehicles. In one embodiment, based on available lots, the charging management device 10 preferentially assigns a charging parking lot 32 with an unused charging station 30 to an electric vehicle in need of charging.

In step S41824, an assignment for standby charging parking lot is performed. In the embodiment, the charging management device 10 allocates charging parking lots 32 for electric vehicles based on the charging priority information. In one embodiment, when an electric vehicle completes charging and releases a charging parking lot 32, the charging management device 10 allocates the charging parking lots 32 for electric vehicles based on the charging priority information. In one embodiment, when the charging management device 10 determines that it can allocate a charging parking lot 32 to an electric vehicle based on the charging priority information, it further allocates the charging parking lot 32 based on available lots, the remaining power of the charging station 30, and the electric vehicle's chargeable power value. For example, if a charging station 30 is equipped with two charging guns corresponding to two charging parking lots 32, and one charging gun is currently in use by an electric vehicle with a remaining power of 30 kW, the charging management device 10 can allocate the other charging parking lot 32 of the charging station 30 to another electric vehicle with a chargeable power value of 25 kW. The embodiment allows multiple electric vehicles to be charged simultaneously from the same charging station 30 at a power level not exceeding the maximum charging power, effectively improving the efficiency of the charging station 30 and enhancing the charging efficiency of the charging point 3.

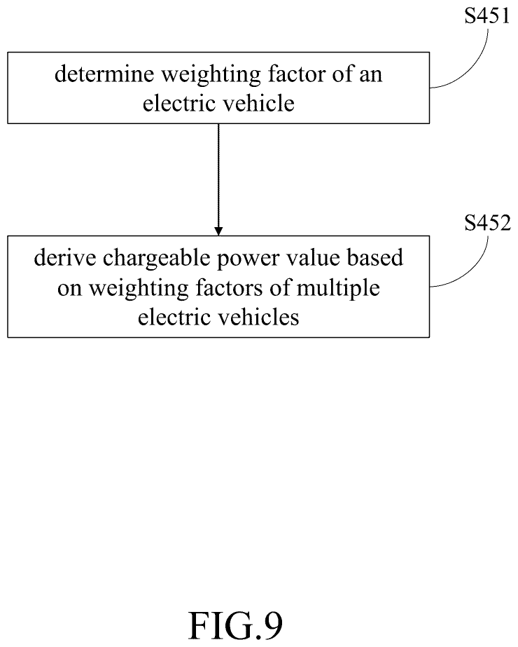

Next, please refer to FIG. 9, a flowchart illustrating determination of the chargeable power value of the electric vehicle according to an embodiment of the application. Wherein, Step S41821 further comprises Steps S451 and S452.

In step S451, the weighting factor of an electric vehicle is determined. In the embodiment, the charging management device 10 calculates the weighting factor of an electric vehicle based on the vehicle's dormant duration, current state of charge (SOC), and estimated SOC. For example, the charging management device 10 can calculate the score using the formula Score=ΔSOC÷(SOC+Tb), where Score represents the weight, ΔSOC is the estimated SOC percentage, SOC is the current SOC percentage, and Tb is the dormant duration. Thus, when the electric vehicle has a higher current SOC and/or dormant duration, its weighting factor is lower, indicating relatively lower charging demand. In the embodiment, the unit of dormant duration is minutes, which should not be construed as limiting.

In one embodiment, the weighting factors for the estimated SOC, current SOC, and dormant duration can be adjusted based on the demand of the charging point 3. However, the adjustment is not limited to specific values or constraints in the application.

In step S452, the chargeable power value is derived based on the weighting factors of multiple electric vehicles. In the embodiment, the charging management device 10 calculates the chargeable power value for electric vehicles based on their weighting factors and the available capacity of charging point 3. For example, the charging management device 10 can compute the formula Pᵢ=(Score÷sum(Score_{1 . . . n}))×P_{C} to determine the chargeable power value for electric vehicles, where Pᵢ represents the chargeable power value, Score denotes the weighted value of the electric vehicle, and P_{c} signifies the available capacity of charging point 3. Therefore, in the embodiment, the charging management device 10 can provide appropriate chargeable power value based on the needs to charge the electric vehicles.

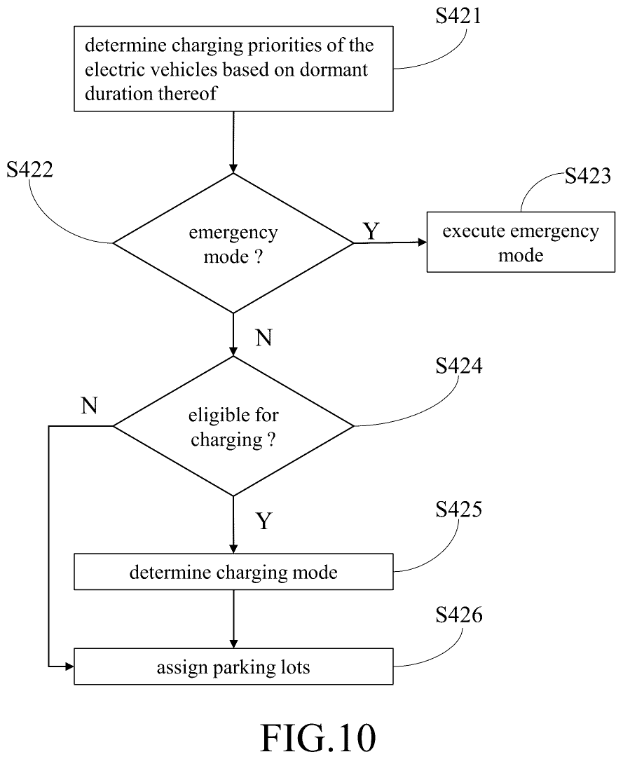

Next, please refer to FIGS. 1 through 10. FIG. 10 is a flowchart of the charging management method under the off-shift mode according to an embodiment of the present application. As illustrated in the embodiment of FIG. 10, step S400 further comprises Steps S421 to S427.

In step S421, the charging priorities of the electric vehicles are determined based on the dormant duration thereof. In the embodiment, the charging management device 10 prioritizes electric vehicles based on their dormant duration to determine charging sequence information for each electric vehicle, where vehicles with shorter dormant durations are given higher priority in the sequence. In the off-shift mode of an electric vehicle, a shorter dormant duration suggests an earlier service schedule to the next day, thus the charging need is more pressing. Thus, through the charging priority determination, the charging management device 10 can rapidly arrange charging based on demand.

Steps S422 to S426 are identical to the previously described steps S414 to S418. Therefore, detailed descriptions will not be reiterated here.

Furthermore, referring back to both FIG. 7 and FIG. 10, in one embodiment, when the charging mode is determined to be normal mode in step 425, step S426 further comprises steps S41811 to S41812 same as FIG. 7, and therefore detailed description will not be reiterated here.

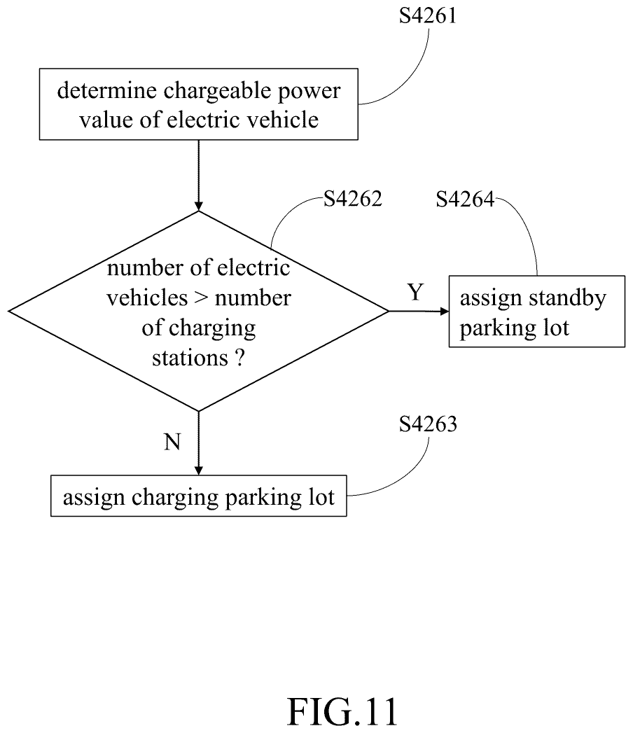

Furthermore, referring to FIGS. 10 and 11, FIG. 11 is a flowchart of the charging management method with automatic mode according to an exemplary embodiment of the application. In one embodiment, when step S425 determines the charging mode to be automatic mode, step S426 further comprises steps S4261 to S4264.

In step S4261, the chargeable power value of the electric vehicle is determined. In the embodiment, the charging management device 10 determines the chargeable power value of the electric vehicle based on the dormant duration of the electric vehicle.

Steps S4262 to S4264 are similar to steps S41822 to S41824 in FIG. 8, and therefore detailed descriptions will not be reiterated here.

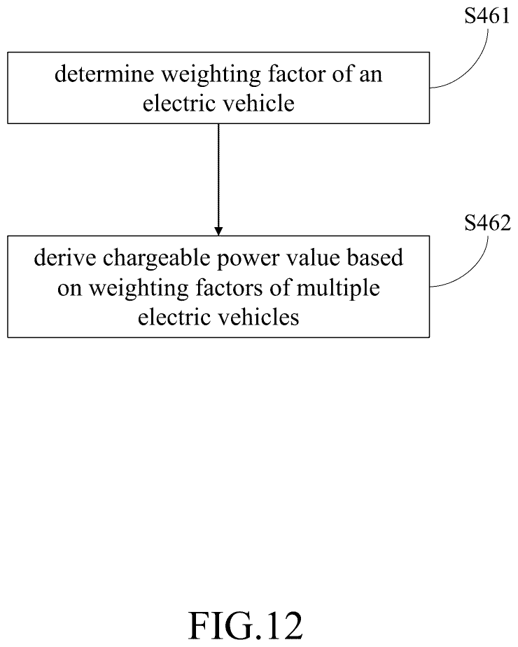

Continuing to refer to FIGS. 11 to 12, FIG. 12 illustrates the process flow for determining the chargeable power value of the electric vehicle according to an embodiment of the application. In the embodiment, Step S4261 further comprises Steps S461 and S462.

In step S461, the weighting factor of the electric vehicle is determined. In one embodiment, the charging management device 10 determines the weighting factor of the electric vehicle based on the instantaneous SOC of the electric vehicle. For example, the charging management device 10 can calculate the score using the formula Score=1÷(SOC), where Score represents the weighting factor, and SOC represents the instantaneous SOC. In another embodiment, the charging management device 10 determines the weighting factor of the electric vehicle based on the dormant duration and the instantaneous SOC of the electric vehicle. For example, the charging management device 10 can calculate the score using the formula Score=1÷(SOC+Tb), where Score represents the weighting factor, SOC represents the instantaneous SOC, and Tb represents the dormant duration.

In one embodiment, the weighting factors of the instantaneous SOC and dormant duration mentioned above can be adjusted based on the requirements of charging point 3, and the present application is not limited to the.

In step S462, the chargeable power value is determined based on the weighting factors of multiple electric vehicles. Step S462 is identical to Step S452 and will not be further elaborated here.

In summary, the application enables the automatic allocation of charging power and charging parking lots for electric vehicles based on individual charging needs and the current charging capacity available at the charging point. The proposed solutions ensure precise and efficient charging of electric vehicles, thereby improving the overall efficiency of the charging point. Furthermore, the application can accurately schedule charging based on real-time updates to the departure schedule, thereby enhancing the charging efficiency of electric vehicles. Additionally, by automatically allocating charging power and charging parking lots, the application prevents multiple electric vehicles requiring high charging power from selecting the same charging station, avoiding situations where electric vehicles cannot charge at the appropriate power level, leading to lower overall charging efficiency at the charging point. Moreover, by implementing the application, automated management of charging points can be achieved, reducing personnel deployment and maintenance costs, and effectively reducing the required costs for establishing charging points.

The above embodiments illustrate only the principles of the present invention and its efficacy, and are not intended to limit the present invention. Any person familiar with this technique may modify or change the above embodiments without violating the spirit and scope of the present invention. Accordingly, all equivalent modifications or alterations made by those who have ordinary knowledge in the technical field without departing from the spirit and technical ideas revealed in the present invention shall still be covered by the claims of the present invention.

1. A charging management method, comprising:
determining a chargeable power value of an electric vehicle based on an operation mode of the electric vehicle and an available capacity of a charging point;
determining a charging parking lot for the electric vehicle based on the chargeable power value and available charging parking lots in the charging point; and
providing information of a charging parking lot to the electric vehicle.

2. The charging management method as claimed in claim 1, wherein the step of determining a chargeable power value of an electric vehicle based on an operation mode of the electric vehicle and an available capacity of a charging point comprises:
determining the operation mode of the electric vehicle based on a dormant duration of the electric vehicle, the operation mode comprising an on-shift mode and an off-shift mode.

3. The charging management method as claimed in claim 2, wherein:
the dormant duration is determined based on an arrival time of the electric vehicle at the charging point and a departure time of a next shift in a service schedule.

4. The charging management method as claimed in claim 3, wherein:
when the next shift in the service schedule has a departure time later than the arrival time on a same day, the operation mode is determined as the on-shift mode; and
when the next shift in the service schedule is the first shift of a next day, the operation mode is determined as the off-shift mode.

5. The charging management method as claimed in claim 2, wherein the step of determining a chargeable power value of an electric vehicle based on an operation mode of the electric vehicle and an available capacity of a charging point comprises:
determining a weighting factor for the electric vehicle; and
determining the chargeable power value based on the weighting factor of the electric vehicle and the available capacity.

6. The charging management method as claimed in claim 5, wherein the step of determining the weighting factor of the electric vehicle further comprises:
in the on-shift mode, determining the weighting factor of the electric vehicle based on the dormant duration, an instantaneous SOC of the electric vehicle, and an estimated SOC of the electric vehicle.

7. The charging management method as claimed in claim 5, wherein the step of determining the weighting factor of the electric vehicle further comprises:
in the off-shift mode, determining the weighting factor of the electric vehicle based on an instantaneous SOC of the electric vehicle.

8. The charging management method as claimed in claim 5, wherein the step of determining the weighting factor of the electric vehicle further comprises:
in the off-shift mode, determining the weighting factor of the electric vehicle based on an instantaneous SOC and the dormant duration of the electric vehicle.

9. The charging management method as claimed in claim 2, further comprising:
determining a charging priority of the electric vehicle by sorting a number of electric vehicles in the charging point.

10. The charging management method as claimed in claim 9, wherein, in the on-shift mode, determining the charging priority of the electric vehicle based on the estimated SOC of the electric vehicle.

11. The charging management method as claimed in claim 9, wherein, in the off-shift mode, determining the charging priority based on the dormant duration of the electric vehicle.

12. A charging management device, comprising:
a memory unit, arranged to operably store a charging management program;
a processor unit, electrically connected to the memory unit, arranged for reading and executing the charging management program to perform a charging management method comprising:
determining a chargeable power value of an electric vehicle based on an operation mode of the electric vehicle and an available capacity of a charging point;
determining a charging parking lot for the electric vehicle based on the chargeable power value and available charging parking lots in the charging point; and
providing information of a charging parking lot to the electric vehicle.

13. The charging management device as claimed in claim 12, wherein the processor unit determines the operation mode of the electric vehicle based on a dormant duration of the electric vehicle, the operation mode comprising an on-shift mode and an off-shift mode.

14. The charging management device as claimed in claim 13, wherein the processor unit is arranged to operably determine the chargeable power value based on a weighting factor of the electric vehicle and the available capacity.

15. The charging management device as claimed in claim 14, wherein, in the duty mode, the processor unit determines the weighting factor of the electric vehicle based on the dormant duration, an instantaneous SOC of the electric vehicle, and an estimated SOC of the electric vehicle.

16. The charging management device as claimed in claim 14, wherein, in the off-shift mode, the processor unit determines the weighting factor of the electric vehicle based on an instantaneous SOC of the electric vehicle.

17. The charging management device as claimed in claim 13, wherein the processor unit determines a charging priority of the electric vehicle by sorting a number of electric vehicles in the charging point.

18. The charging management device as claimed in claim 17, wherein, in the on-shift mode, the processor unit determines the charging priority of the electric vehicle based on the estimated SOC of the electric vehicle.

19. The charging management device as claimed in claim 17, wherein, in the off-shift mode, the processor unit determines the charging priority of the electric vehicles based on the dormant duration of the electric vehicle.

20. An intelligent charging management system, comprising:
a plurality of charging stations, arranged at a charging point; and
a charging management device as claimed in claim 14, communicatively connected to the plurality of charging stations, and outputting a charge current command to a corresponding charging station based on a chargeable power value of an electric vehicle.
